(19) United States
(12) Patent Application Publication
(10) Pub. No.: US 2014/0082549 A1
(43) Pub. Date: Mar. 20, 2014

(54) ELECTRONIC DEVICE CAPABLE OF CONTROLLING DISPLAY OF CONTENT IN PASSWORD BOX

(71) Applicants: HONG FU JIN PRECISION INDUSTRY (SHENZHEN) CO., LTD., Shenzhen (CN); HON HAI PRECISION INDUSTRY CO., LTD., New Taipei (TW)

(72) Inventor: CHAO-JUN XIAO, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 13/848,032

(22) Filed: Mar. 20, 2013

(30) Foreign Application Priority Data
Sep. 17, 2012 (CN) 2012103442692

(51) Int. Cl. G06F 3/0484

(52) U.S. Cl. CPC G06F 3/0484
USPC 715/780

(57) ABSTRACT

An electronic device includes a display unit, an input unit; and a processing unit. The processing unit displays a password box on the display unit in response to user's operation on the input unit. The processing unit further displays a symbol in the password box when a character of a password is input through the input unit. When finishing input of the password, at least two of all the symbols displayed in the password box are different.

### BACKGROUND

1. Technical Field

The present disclosure relates to electronic devices, and particularly to an electronic device with a function of controlling display of content in a password box.

2. Description of Related Art

When inputting a password, a number of symbols (e.g., *) are displayed in a password box instead of the actual characters typed. After finishing input of a password, all the symbols in the password box are same, which may cause password input to be monotonous and less interactive.

### BRIEF DESCRIPTION OF THE DRAWINGS

The components of the drawings are not necessarily drawn to scale, the emphasis instead being placed upon clearly illustrating the principles of the present disclosure. Moreover, in the drawings, like reference numerals designate corresponding parts throughout several views.

FIG. 1 is a block diagram of an electronic device capable of controlling display of content in a password box, in accordance with an exemplary embodiment.

FIGS. 2-6 are schematic views showing content displayed in the password box.

### DETAILED DESCRIPTION

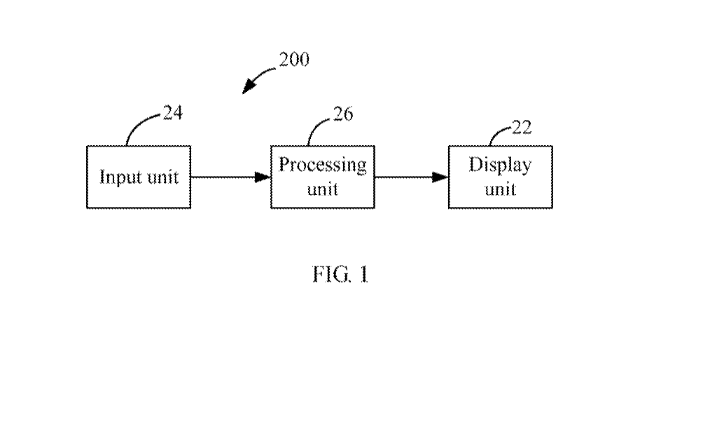

FIG. 1 shows an embodiment of an electronic device 200 capable of controlling display of content in a password box. The electronic device 200 includes a display unit 22, an input unit 24, and a processing unit 26. The processing unit 26 displays a login interface including a password box 262 on the display unit 22 in response to user's operation on the input unit 24. The processing unit 26 further displays a distinctive symbol in the password box 262 when a character of a password is input through the input unit 24, so that after finishing input of a password, at least two of all the symbols displayed in the password box 262 are different. In a first embodiment, during inputting a password, each symbol corresponding to each input character of the password is displayed in the password box 262 when the input of the password is finished. In a second embodiment, during inputting a password, only the symbol corresponding to the currently input character of the password is displayed in the password box 262. That is, after finishing input of the password, only the symbol corresponding to the lastly input character of the password is displayed in the password box 262. In the second embodiment, each symbol is a sentence or an image.

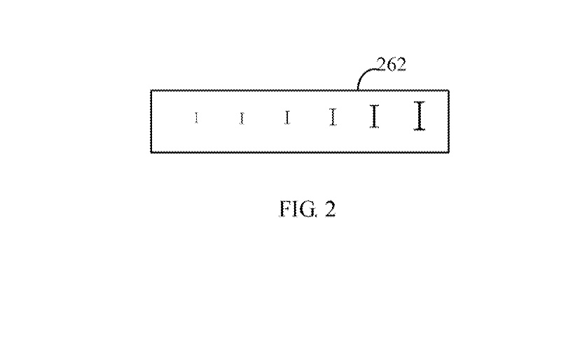

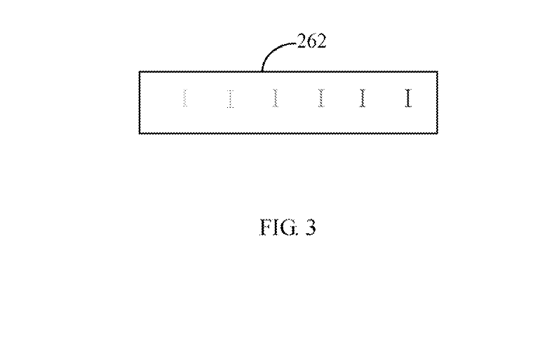

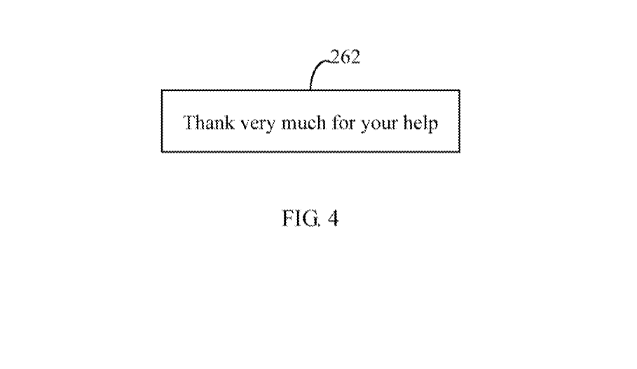

If each symbol corresponding to each input character of the password is displayed in the password box 262 when the input of a password is finished, in one embodiment, the size of the displayed symbols gradually increases (see FIG. 2) or decreases. In another embodiment, the color of the displayed symbols gradually deepens (see FIG. 3) or gradually becomes lighter, thus achieving the distinctiveness between the displayed symbols. The displayed symbol can be a word or an image. Furthermore, if each displayed symbol is a word, after finishing the input of a password, all the displayed symbols in the password box consists of a sentence, for example, “thank very much for your help” (see FIG. 4).

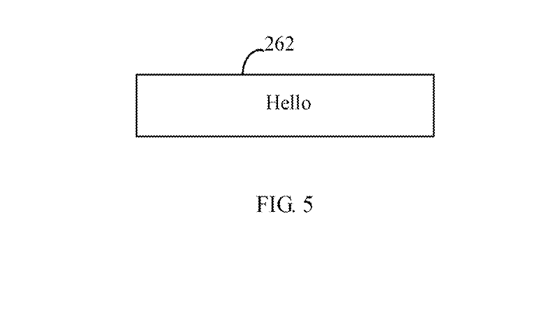

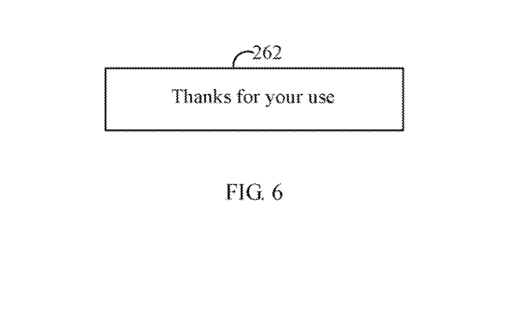

FIGS. 5-6 show the displayed symbol when only the symbol corresponding to the currently input character of the password is displayed in the password box 262. When the first character of a password is input, “Hello” is displayed in the password box 262. When the second character of the password is input, “Hello” disappears, and “thanks for your use” is subsequently displayed in the password box 262, and the like, when finishing the input of the password, only the symbol corresponding to the last character of the password is displayed in the password box 262.

With such configuration, during password input, the symbols displayed in the password box 262 gradually change, which may break the monotony when inputting a password.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. An electronic device comprising:
a display unit;
an input unit; and
a processing unit to control the display unit to display a password box in response to user's operation on the input unit, and display a distinctive symbol in the password box when a character of a password is input through the input unit, so that after finishing input of the password, at least two of all the symbols displayed in the password box are different.

2. The electronic device as described in claim 1, wherein during inputting the password, each symbol corresponding to each input character of the password is displayed in the password box when the input of the password is finished.

3. The electronic device as described in claim 2, wherein the size of the displayed symbols in the password box gradually increases.

4. The electronic device as described in claim 2, wherein the size of the displayed symbols in the password box gradually decreases.

5. The electronic device as described in claim 2, wherein the color of the displayed symbols in the password box gradually deepens.

6. The electronic device as described in claim 2, wherein the color of the displayed symbols in the password box gradually becomes lighter.

7. The electronic device as described in claim 2, wherein each displayed symbol in the password box is a word.

8. The electronic device as described in claim 2, wherein each displayed symbol in the password box is an image.

9. The electronic device as described in claim 1, wherein during inputting the password, only the symbol corresponding to the currently input character of the password is displayed in the password box.

10. The electronic device as described in claim 9, wherein each displayed symbol in the password box is a sentence.

11. The electronic device as described in claim 9, wherein each displayed symbol in the password box is an image.
